(19) United States
(12) Patent Application Publication
(10) Pub. No.: US 2006/0197766 A1
(43) Pub. Date: Sep. 7, 2006

(54) System for interpretation of streaming data filters

(75) Inventor: Gilad Raz, Mevaseret Tzion (IL)

Correspondence Address: DANIEL J SWIRSKY, 55 REUVEN ST., BEIT SHEMESH, 99544, IL

(73) Assignee: Digital Fuel Technologies, Inc.

(21) Appl. No.: 11/072,516

(22) Filed: Mar. 7, 2005

(51) Int. Cl. G06T 1/20

(52) U.S. Cl. 345/506

(57) ABSTRACT

A method for processing streaming data, including selecting a flow having a plurality of operations configured to be applied to streaming data, and executing any of the operations defined in the flow, where the operations are executed on the streaming data, where the operations are executed in a series of discrete stages, during each stage performing a discrete function in a multi-stage operation, and where the operations are executed incrementally, processing each new part of the streaming data as it becomes available for processing.

### FIELD OF THE INVENTION

The present invention relates to streaming data processing in general, and more particularly to the processing of streaming data filters.

### BACKGROUND OF THE INVENTION

Streaming data processing has the potential of placing real-time information in the hands of decision makers. Streaming data typically arrives from one or more data sources and may be aggregated in a centralized repository. A data source may be as erratic as traffic accident reports or as dependable and uniform as a clock. The real-time data arriving from the data sources may provide crucial information necessary for on-the-time decisions. For example, the analysis of traffic reports may indicate a faulty roadway and enable those responsible for roadway maintenance to react appropriately.

The dynamic nature of streaming data, its constant motion, makes it difficult to process. By definition streaming data represents a continuous flow of information, in contrast to data that is typically processed discretely. While a filter of static data may include a complex set of functions performed on the static data once in a single large computationally expensive step, a filter of streaming data may need to be employed numerous times in response to the arrival of new data. Moreover, even a static data filter may require modification, causing difficulties in refashioning the filter. For example, modification to an SQL filter typically requires great care, due to the sensitive nature of SQL's syntactical structure.

### SUMMARY OF THE INVENTION

In one aspect of the present invention a method is provided for processing streaming data, the method including selecting a flow having a plurality of operations configured to be applied to streaming data, and executing any of the operations defined in the flow, where the operations are executed on the streaming data, where the operations are executed in a series of discrete stages, during each stage performing a discrete function in a multi-stage operation, and where the operations are executed incrementally, processing each new part of the streaming data as it becomes available for processing.

In another aspect of the present invention the executing step includes executing each of the operations in an independent computational thread.

In another aspect of the present invention the method further includes selecting a template associated with a first flow, where the template includes at least one missing parameter value, and modifying the template by assigning a value to any of the parameters, thereby creating a second flow.

In another aspect of the present invention the method further includes representing the flow as a graph, where the graph includes at least one edge and at least one arc, where the edge represents an operation of the flow, and where the arc represents a dependency relationship between two of the operations.

In another aspect of the present invention the executing step includes executing the dependent operation after executing the operation on which it depends.

In another aspect of the present invention the method further includes adding a new operation edge into the flow graph subsequent to executing the operations in the flow, and defining a new dependency arc for the new edge with respect to at least one of the edges in the graph.

In another aspect of the present invention the method further includes executing only the added operation among the previously-executed operations in the flow.

In another aspect of the present invention the method further includes a) identifying any of the operations in the graph that does not depend on any other of the operations in the graph, b) executing the identified operations, c) identifying any of the not-yet-executed operations in the graph where all of the operations upon which the not-yet-executed operation depends have been executed, d) executing the identified not-yet-executed operations, and e) performing steps c) and d) until all of the operations have been executed.

In another aspect of the present invention the method further includes adding a new operation edge into the flow graph subsequent to executing the operations in the flow, defining a new dependency arc for the new operation with respect to at least one of the operations in the graph treating any of the operations which depend on the new operation as not-yet-executed operations, and performing steps c) and d) until all of the operations have been executed, executing only the added operation and the not-yet-executed operations among the previously-executed operations in the flow.

In another aspect of the present invention a system is provided for processing streaming data, the system including means for selecting a flow having a plurality of operations configured to be applied to streaming data, and means for executing any of the operations defined in the flow, where the operations are executed on the streaming data, where the operations are executed in a series of discrete stages, during each stage performing a discrete function in a multi-stage operation, and where the operations are executed incrementally, processing each new part of the streaming data as it becomes available for processing.

In another aspect of the present invention the means for executing is operative to execute each of the operations in an independent computational thread.

In another aspect of the present invention the system further includes means for selecting a template associated with a first flow, where the template includes at least one missing parameter value, and means for modifying the template by assigning a value to any of the parameters, thereby creating a second flow.

In another aspect of the present invention the system further includes means for representing the flow as a graph, where the graph includes at least one edge and at least one arc, where the edge represents an operation of the flow, and where the arc represents a dependency relationship between two of the operations.

In another aspect of the present invention the means for executing is operative to execute the dependent operation after executing the operation on which it depends.

In another aspect of the present invention the system further includes means for adding a new operation edge into the flow graph subsequent to executing the operations in the flow, and means for defining a new dependency arc for the new edge with respect to at least one of the edges in the graph.

In another aspect of the present invention the system further includes means for executing only the added operation among the previously-executed operations in the flow.

In another aspect of the present invention the system further includes a) means for identifying any of the operations in the graph that does not depend on any other of the operations in the graph, b) means for executing the identified operations, c) means for identifying any of the not-yet-executed operations in the graph where all of the operations upon which the not-yet-executed operation depends have been executed, d) means for executing the identified not-yet-executed operations, and e) means for performing steps c) and d) until all of the operations have been executed.

In another aspect of the present invention the system further includes means for adding a new operation edge into the flow graph subsequent to executing the operations in the flow, means for defining a new dependency arc for the new operation with respect to at least one of the operations in the graph means for treating any of the operations which depend on the new operation as not-yet-executed operations, and means for performing steps c) and d) until all of the operations have been executed, executing only the added operation and the not-yet-executed operations among the previously-executed operations in the flow.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a system for processing streaming data, constructed and operative in accordance with a preferred embodiment of the present invention;

FIG. 1B is a simplified flowchart illustration of a method for processing streaming data, operative in accordance with a preferred embodiment of the present invention;

FIG. 1C is a simplified pictorial illustration of auxiliary tables employed in the processing of streaming data, useful in understanding the present invention;

FIG. 2A is a simplified pictorial illustration of an exemplary flow and its corresponding representation in a database, useful in understanding the present invention;

FIG. 2B is a simplified pictorial illustration of an extension to a flow and its corresponding representation in a database, useful in understanding the present invention;

FIGS. 3A, 3B and 3C, taken together, is a simplified flowchart illustration of a method for processing a flow, operative in accordance with a preferred embodiment of the present invention;

FIGS. 4A and 4B, taken together, is a simplified pictorial illustration of exemplary tables used in interpreting flows, constructed in accordance with a preferred embodiment of the present invention; and

FIG. 4C, is a simplified pictorial illustration of exemplary tables after extension, constructed in accordance with a preferred embodiment of the present invention.

### DETAILED DESCRIPTION OF PREFERRED EMBODIMENTS

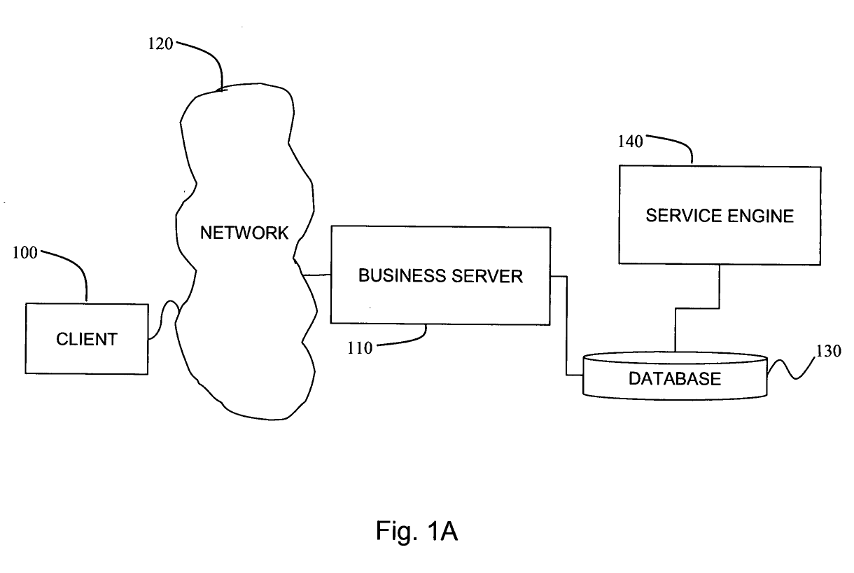

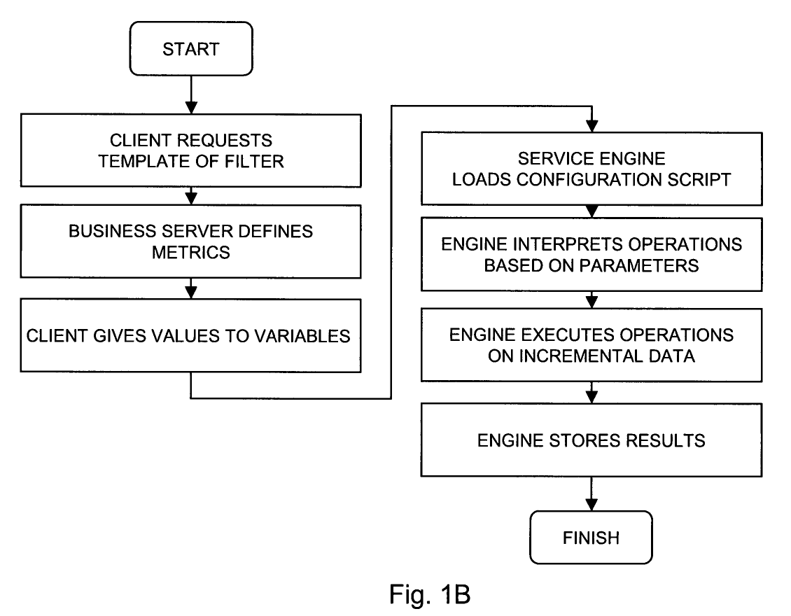

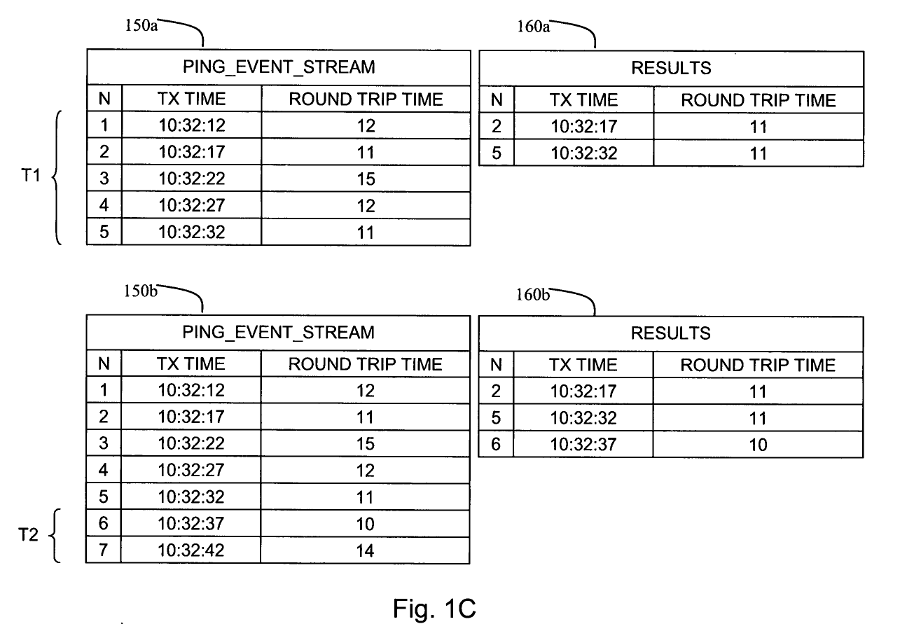

Reference is now made to FIG. 1A, which is a simplified pictorial illustration of a system for processing streaming data, constructed and operative in accordance with a preferred embodiment of the present invention, FIG. 1B, which is a simplified flowchart illustration of a method for processing streaming data, operative in accordance with a preferred embodiment of the present invention and FIG. 1C, which is a simplified pictorial illustration of auxiliary tables employed in the processing of streaming data. In the method of FIG. 1B, a client 100 requests from a business server 110 to construct a new flow. A flow is defined herein as a flexible method of processing streaming data that includes one or more variables that may be adjusted in accordance with different modes of operation. Client 100 preferably sends a request over a network 120, such as an Intranet, to business server 110 for a template, such as one that is associated with an existing flow, for the purpose of modifying the template and thereby defining the new flow. A template is defined herein as a specific instance of a flow. For example, client 100 may wish to construct a new flow for determining the relative performance of a resource, such as a computer among a group of computers. The user of client 100 may wish to determine if a particular computer is available as often as the other computers in the group. Client 100 then requests a template of an existing flow, where the template describes a method for determining the relative performance of a resource, such as of a power station.

Business server 110 preferably returns the template. The template for the flow preferably includes a series of operations, which may be executed to process streaming data. The template preferably includes a set of parameters associated with the operations, such as may be used to define which streaming data source should be processed, which field within the streaming data source should be used as a measure of performance, and how to evaluate the performance of the resource. The template may then be modified to construct the new flow. For example, the following template describes a flow for determining the relative performance of a resource, where missing parameter values are marked with square braces (‘[ ]’):

```
<Operator op=aggregate_4 stream=[ ]>
  <AggregationTime scale=[ ] />
  <Result name=aggregate_4_output />
</Operator>
<Operator op=evaluate_3 stream=aggregate_4_output>
  <Perform op=[ ] input=stream />
  <Result name=evalute_3_output />
</Operator>
<Operator op=aggregate_2 stream=[ ]>
  <AggregationTime scale=[ ] />
  <Result name=aggregate_2_output />
</Operator>
<Operator op=evaluate_1>
  <Perform op=[ ]>
    <Input name=aggregate_2_output />
    <Input name=evalute_3_output />
  </Perform>
  <Result name=evalute_1_output />
</Operator>
```

The user of client 100 may wish to adapt the template to construct a new flow that processes ping data and evaluates the ping data to determine the performance of a first group of computers relative to a second group based on the average round trip time of a ping that is sent from each of the computers to/from the ping server. The streaming data arriving from the ping server, namely the ping data, may include three fields: the identity of the originating computer, the time the ping was transmitted and the round trip time of the ping. The user may copy the template and modify the template, inserting appropriate parameter values wherever a missing parameter value exists, to create the following flow:

```
<Operator op=aggregate_4 stream=PING_1>
  <AggregationTime scale=MONTH />
  <Result name=aggregate_4_output />
</Operator>
<Operator op=evaluate_3 stream=aggregate_4_output>
  <Perform op=AVG input=stream />
  <Result name=evalute_3_output />
</Operator>
<Operator op=aggregate_2 stream=PING_2>
  <AggregationTime scale=MONTH(1) />
  <Result name=aggregate_2_output />
</Operator>
<Operator op=evaluate_1>
  <Perform op=STD>
    <Input name=aggregate_2_output />
    <Input name=evalute_3_output />
  </Perform>
  <Result name=evalute_1_output />
</Operator>
```

Business server 110 preferably stores the constructed flow with its associated parameters/variables defined by the user of client 100 in a database 130, such as a relational database.

A service engine 140 preferably retrieves the flow stored by business server 110 and interprets the flow in order to process the streaming data with which the flow is concerned. Service engine 140 preferably executes each operation defined in the flow in an independent computational thread. Moreover, the execution of an operation may be performed in a series of discrete stages, each stage performing a discrete function in a multi-stage operation. For example, the operation which calculates a standard deviation may be executed in two stages. In first stage the mean may be calculated and in the next stage the deviation from the mean.

Service engine 140 preferably executes the flow's operations incrementally, processing each new part of the data as it becomes available for processing. In this fashion, once an operation in a flow has been executed on a data stream, subsequent execution will be limited to the incremental changes in the data stream.

In the example shown in FIG. 1C, service engine 140 executes a ‘filter’ operation, which extracts all the entries in a ping data stream that have a round trip time less than or equal to 11 milliseconds. Table 150a depicts the ping data stream at a first time, T1, in which five entries are available. Service engine 140 executes the ‘filter’ operation on the entire table 150a, namely on all five rows, to create a results table 160a, which contains only the rows in which the round trip time is less than or equal to 11 milliseconds. At time T2 the ping data stream includes two additional rows shown as table 150b. Service engine 140 preferably limits the execution of the ‘filter’ operation to those two new rows, rows 6 and 7, and appends the results of the operation to the existing results table, shown as table 160b.

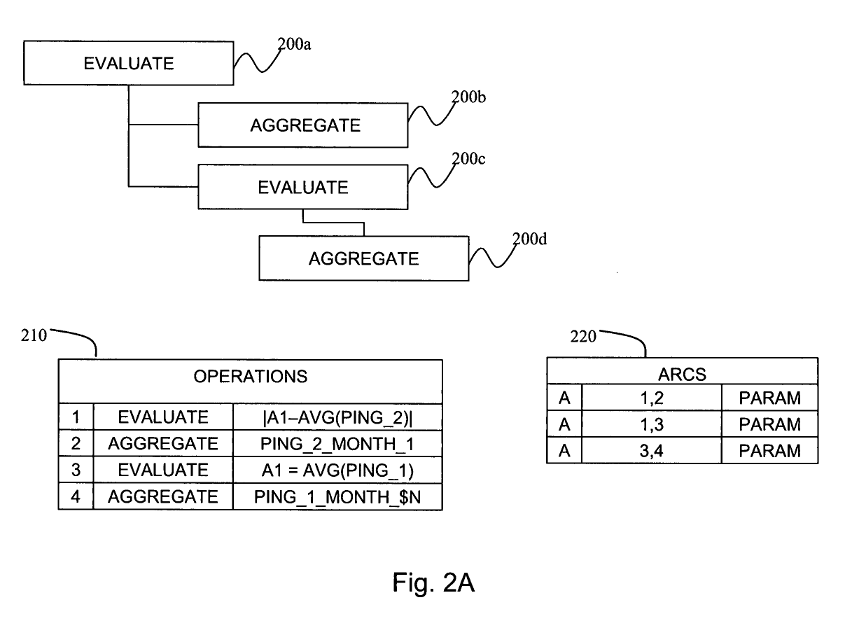

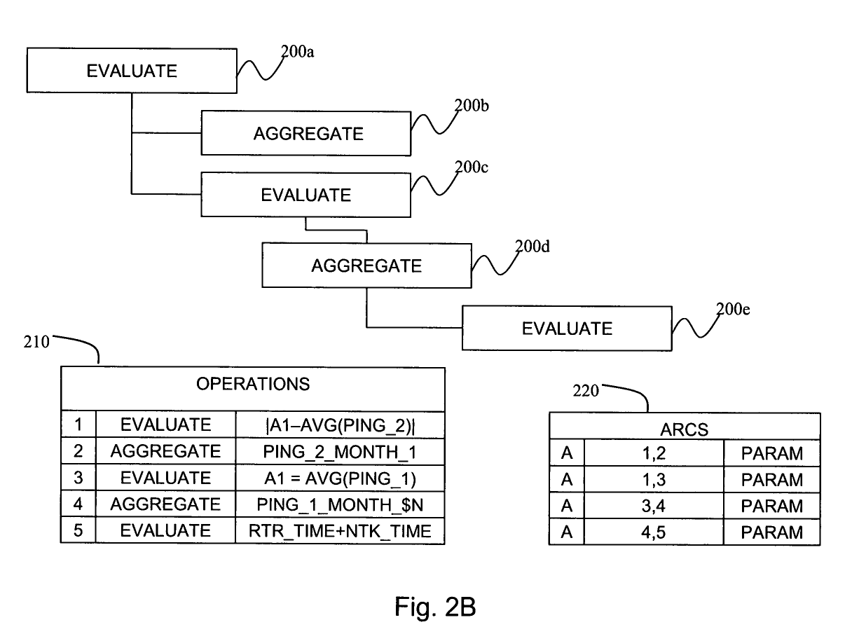

Reference is now made to FIG. 2A, which is a simplified pictorial illustration of an exemplary flow and its corresponding representation in a database, useful in understanding the present invention. A flow, constructed through the process described hereinabove with reference to FIG. 1, may be represented as a graph, with edges and arcs, as shown in FIG. 2A. Each edge of the graph preferably represents an operation, and the arcs represent the relationship between operations. For example, in FIG. 2A, operation 200a, labeled EVALUATE, is associated with a flow operation that evaluates data in a stream and is dependent on the result of operation 200b, labeled AGGREGATE, and operation 200c, labeled EVALUATE. In this example, operations 200b and 200c may be called the children of operation 200a, as a result of operation 200a's dependency on them.

The flow is preferably stored by business server 110 in database 130 (FIG. 1), in which the edges are placed in a table 210, labeled OPERATIONS, in FIG. 2A, and the arcs in a table 220, labeled ARCS, in FIG. 2A. Each operation 200 is preferably placed in table 210 and given a unique identifier. The relationship between operations 200 is preferably stored in table 220 employing this unique identifier. Thus, in the example shown in FIG. 2A, operation 200a is placed in the first entry in table 210, operation 200b in the second entry, operation 200c in the third and operation 200d in the fourth. The relationship between the operation stored in table 220 indicates that the operations identified as 2 and 3 are children of the operation identified as 1, and the operation identified as 4 is a child of the operation identified as 3.

When processing a flow, service engine 140 preferably executes an operation's children prior to the execution of an operation. In this manner a flow is processed from the bottom up, starting with the children and working its way up to the head of the graph.

Continuing the example described in FIG. 1, client 100 may request that the average of the round trip time for all computers in a first group be calculated for a variable period of time, such as one month, the exact month to be defined later, and that this average be employed to calculate the deviation of the performance of a second group of computers during a fixed period of time, such as the past month. The parameters that define these operations are preferably stored in table 210, as shown in FIG. 2A, alongside the operations.

Reference is now made to FIG. 2B, which is a simplified pictorial illustration of an extension to a flow and its corresponding representation in a database, useful in understanding the present invention. The flow described in FIG. 2A may be extended by a user of client 100 to include further functionality, such as by adding additional operations. In the example depicted in FIG. 2B, the user of client 100 extends the flow to include an additional EVALUATE operation 200e that calculates the actual round trip time as the sum of the time from a computer to the router and the time spent over the network. The additional functionality is preferably incorporated into the flow previously stored by business server 110, preferably without requiring the user to make any other modification to the pre-existing flow, by creating a new arc and edge for the operation, defining the arc dependency relationship between the new operation edge and one or more existing operation edges. Service engine 140 preferably processes the extension to the flow without reprocessing the entire flow whenever possible. In the example described above, service engine 140 may re-execute operations 200e, 200d and 200c after the user of client 100 extends the flow, and preferably does not re-execute operation 200b.

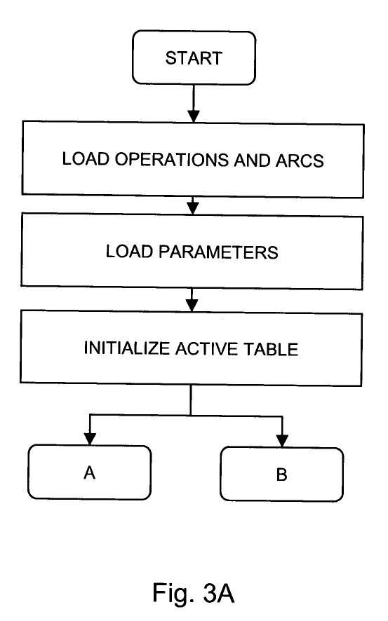

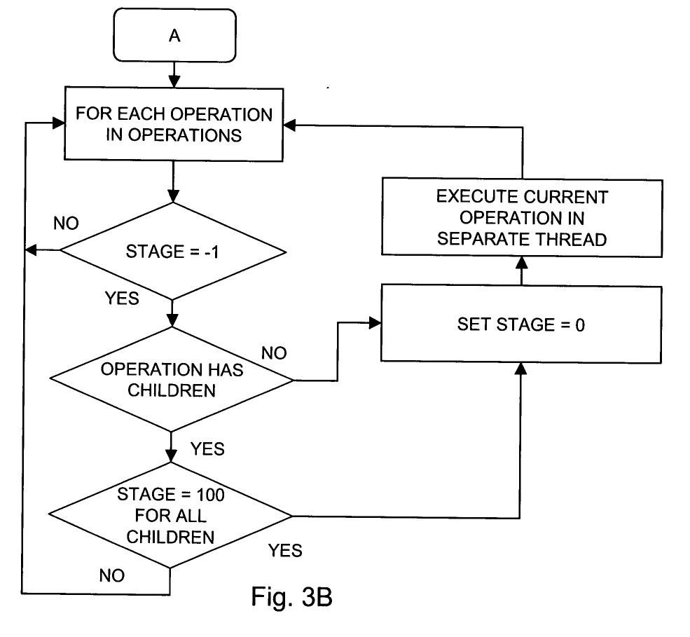

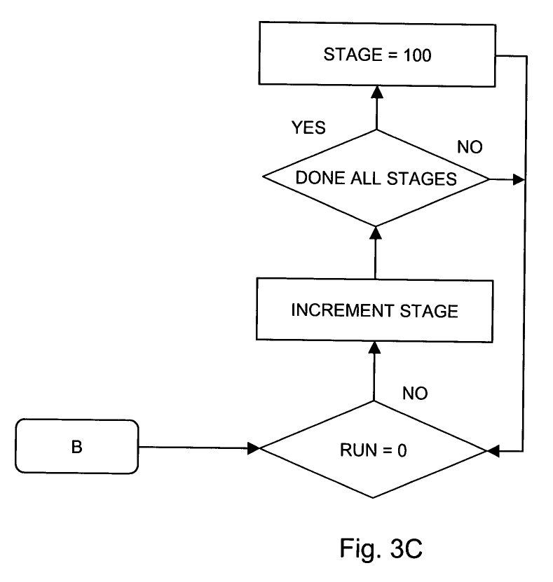

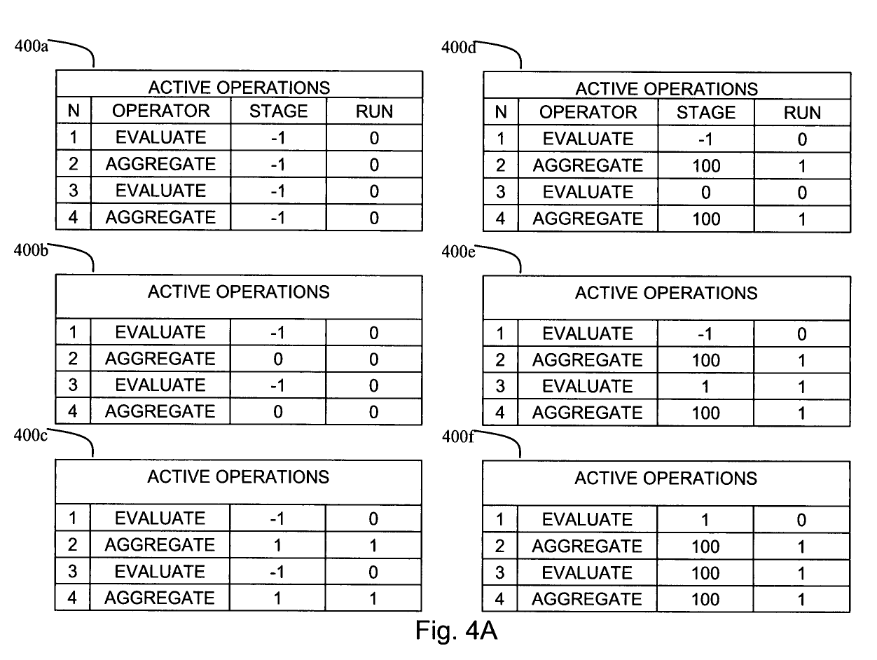

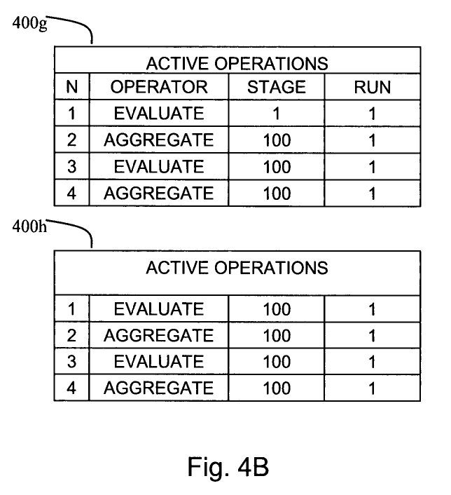

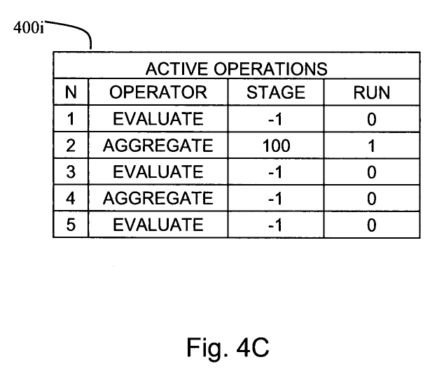

Reference is now made to FIGS. 3A, 3B and 3C, which taken together, is a simplified flowchart illustration of a method for processing a flow, operative in accordance with a preferred embodiment of the present invention. In the method of FIG. 3A, service engine 140 preferably loads the flow previously stored by business server 110, as described hereinabove with reference to FIGS. 1A and 1B, reading the flow's operations from its associated table 210 and arcs 220 from database 130 including any parameters associated with the tables. Service engine 140 preferably maintains an operation activity table 400, shown in FIGS. 4A-4C, which records operation activity. Engine 140 populates activity table 400 with the list of operations and their respective identifiers retrieved from table 210. Service engine 140 preferably adds two columns to activity table 400, STAGE and RUN, where STAGE is employed to preserve the current stage in the processing of an operation and RUN is employed to determine the current state of execution. During the initialization of activity table 400, service engine 140 preferably sets the initial value of the STAGE field to −1 and RUN to 0 for each of the entries. Service engine 140 then performs the following iterative process (shown in FIG. 3B):

1. For each operation in the OPERATIONS table
a. Does STAGE equal −1 for the current operation?
   i. If not go to the next operation (step 1).
   ii. If it does,
      1. Determine the children of the current operation following the information found in ARCS 220.
      2. Have all the children of the current operation finished processing? (If there are children, check if STAGE equals a predefined end-of-processing value, such as 100, for all the children of the current operation)
         a. If not go to next operation (step 1).
         b. If all the children have finished processing then:
         i. Set stage equal to a predefined start-of-processing value, such as 0, to indicate beginning of processing
         ii. Execute the current operation in a separate thread updating the RUN field with the status of execution (e.g., 1=running, 0=not running).
         iii. Return to search for the next operation (step 1)
            Additionally, service engine 140 preferably runs the following second iterative process, concurrent to the first described above, to synchronize the values in activity table 400 with the status of the execution threads, as follows:

2. Monitor status of executing operation
a. If the RUN field does not equal the start-of-processing value, increment stage
b. If the execution of the operation has reached the final stage, set stage equal to the end-of-processing value
   Service engine 140 typically updates the RUN field of an operation at the beginning and end of its execution.

Reference is now made to FIGS. 4A and 4B, which taken together, is a simplified pictorial illustration of exemplary tables used in interpreting flows, constructed in accordance with a preferred embodiment of the present invention. In the example of FIGS. 4A and 4B service engine 140 interprets the flow shown in FIG. 2 in six interpretation steps. The flow utilizes four operations, namely AGGREGATE, EVALUATE, AGGREGATE, and EVALUATE, to determine the relative deviation of the performance of a first group of computers as compared to a second group of computers over a period of time. Continuing the example described above, client 100 may chose the round trip time of a ping as the measure of performance and the period of time analyzed for the first group of computers as the month of January, and the period of time analyzed for the second group of computers as the past month, March. During an initialization step, shown in FIG. 4, STAGE is preferably set to −1 and RUN set to 0 for all the operations in active 400a.

Next, service engine 140 begins the iterative process described hereinabove with reference to FIG. 3B to determine which operation to execute. Since operations 4 and 2 are at stage −1 and have no child operations, service engine 140 sets their STAGE to 0 in active 400b and executes them in separate threads. Operation 4 aggregates the streaming data from database 130, selecting only entries which originated from the first group of ping servers in the month of January while operation 2 similarly aggregates the streaming data from database 130, selecting only entries which originated from the second group of ping servers in the past month of March.

When operations 4 and 2 finish their execution, service engine 140 preferably sets RUN to 1, as described hereinabove with reference to FIG. 3C, and increments their STAGE in active 400c. Since operations 4 and 2 are single stage operations, and hence they have finished their operation, service engine 140 sets STAGE to 100 in active 400d and, following the method described in FIG. 3B, service engine 140 selects the next operation for interpretation, operation 3, and sets its STAGE to 0 in active 400d. Service engine 140 executes operation 3, which then evaluates the mean round trip time found in the entries aggregated by operation 4.

When operation 3 finishes its execution, service engine 140 sets its RUN to 1, as described hereinabove with reference to FIG. 3C, and increments its STAGE in active 400e. Since operation 3 is a single stage operation, and hence has finished its operation, service engine 140 sets its STAGE to 100 in active 400f and following the method described in FIG. 3B, service engine 140 selects the next operation for interpretation, operation 1, setting its STAGE to 0 in active 400f. Real-time engine executes operation 1, which evaluates the mean round trip time found in the entries aggregated by operation 2 and further evaluates the deviation of the mean evaluated by operation 3 with the mean evaluated by operation 1.

When operation 1 finishes its execution, service engine 140 sets its RUN to 1, as described hereinabove with reference to FIG. 3C, and increments its STAGE in active 400g. Since operation 1 is a single stage operation, and hence has finished its operation, service engine 140 sets its STAGE to 100 in active 400h. The resultant output is preferably stored in database 130 and made available to client 100.

Reference is now made to FIG. 4C, which is a simplified pictorial illustration of exemplary tables after extension, constructed in accordance with a preferred embodiment of the present invention. As described hereinabove with reference to FIG. 2B, client 100 may extend the flow, such as by incorporating an additional operation. In the example depicted in FIG. 4C, the addition of a new operation 5, labeled EVALUATE, to the flow is recorded in table 400i with the addition of a row. When service engine 140 next interprets the flow, operation 2, labeled AGGREGATE, will preferably not be re-executed, since its parameters and data have not changed. Rather, service engine 140 preferably sets the STAGE for operation 2 EVALUATE to 100, to represent that it has finished processing, and continues interpretation of the flow as described hereinabove with reference to FIGS. 4A and 4B.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for processing streaming data, the method comprising:
selecting a flow having a plurality of operations configured to be applied to streaming data; and
executing any of said operations defined in said flow, wherein said operations are executed on said streaming data, wherein said operations are executed in a series of discrete stages, during each stage performing a discrete function in a multi-stage operation, and wherein said operations are executed incrementally, processing each new part of said streaming data as it becomes available for processing.

2. A method according to claim 1 wherein said executing step comprises executing each of said operations in an independent computational thread.

3. A method according to claim 1 and further comprising:
selecting a template associated with a first flow, wherein said template includes at least one missing parameter value; and
modifying said template by assigning a value to any of said parameters, thereby creating a second flow.

4. A method according to claim 1 and further comprising representing said flow as a graph, wherein said graph includes at least one edge and at least one arc, wherein said edge represents an operation of said flow, and wherein said arc represents a dependency relationship between two of said operations.

5. A method according to claim 4 wherein said executing step comprises executing said dependent operation after executing the operation on which it depends.

6. A method according to claim 4 and further comprising:
adding a new operation edge into said flow graph subsequent to executing said operations in said flow; and
defining a new dependency arc for said new edge with respect to at least one of said edges in said graph.

7. A method according to claim 6 and further comprising executing only said added operation among said previously-executed operations in said flow.

8. A method according to claim 4 and further comprising:
a) identifying any of said operations in said graph that does not depend on any other of said operations in said graph;
b) executing said identified operations;
c) identifying any of said not-yet-executed operations in said graph where all of the operations upon which said not-yet-executed operation depends have been executed;
d) executing said identified not-yet-executed operations; and
e) performing steps c) and d) until all of said operations have been executed.

9. A method according to claim 8 and further comprising:
adding a new operation edge into said flow graph subsequent to executing said operations in said flow;
defining a new dependency arc for said new operation with respect to at least one of said operations in said graph treating any of said operations which depend on said new operation as not-yet-executed operations; and
performing steps c) and d) until all of said operations have been executed, executing only said added operation and said not-yet-executed operations among said previously-executed operations in said flow.

10. A system for processing streaming data, the system comprising:
means for selecting a flow having a plurality of operations configured to be applied to streaming data; and
means for executing any of said operations defined in said flow, wherein said operations are executed on said streaming data, wherein said operations are executed in a series of discrete stages, during each stage performing a discrete function in a multi-stage operation, and wherein said operations are executed incrementally, processing each new part of said streaming data as it becomes available for processing.

11. A system according to claim 10 wherein said means for executing is operative to execute each of said operations in an independent computational thread.

12. A system according to claim 10 and further comprising:
means for selecting a template associated with a first flow, wherein said template includes at least one missing parameter value; and
means for modifying said template by assigning a value to any of said parameters, thereby creating a second flow.

13. A system according to claim 10 and further comprising means for representing said flow as a graph, wherein said graph includes at least one edge and at least one arc, wherein said edge represents an operation of said flow, and wherein said arc represents a dependency relationship between two of said operations.

14. A system according to claim 13 wherein said means for executing is operative to execute said dependent operation after executing the operation on which it depends.

15. A system according to claim 13 and further comprising:
means for adding a new operation edge into said flow graph subsequent to executing said operations in said flow; and
means for defining a new dependency arc for said new edge with respect to at least one of said edges in said graph.

16. A system according to claim 15 and further comprising means for executing only said added operation among said previously-executed operations in said flow.

17. A system according to claim 13 and further comprising:
a) means for identifying any of said operations in said graph that does not depend on any other of said operations in said graph;
b) means for executing said identified operations;
c) means for identifying any of said not-yet-executed operations in said graph where all of the operations upon which said not-yet-executed operation depends have been executed;
d) means for executing said identified not-yet-executed operations; and
e) means for performing steps c) and d) until all of said operations have been executed.

18. A system according to claim 17 and further comprising:
means for adding a new operation edge into said flow graph subsequent to executing said operations in said flow;
means for defining a new dependency arc for said new operation with respect to at least one of said operations in said graph means for treating any of said operations which depend on said new operation as not-yet-executed operations; and
means for performing steps c) and d) until all of said operations have been executed, executing only said added operation and said not-yet-executed operations among said previously-executed operations in said flow.

19. A computer-implemented program embodied on a computer-readable medium, the computer program comprising:
a first code segment operative to select a flow having a plurality of operations configured to be applied to streaming data; and
a second code segment operative to execute any of said operations defined in said flow, wherein said operations are executed on said streaming data, wherein said operations are executed in a series of discrete stages, during each stage performing a discrete function in a multi-stage operation, and wherein said operations are executed incrementally, processing each new part of said streaming data as it becomes available for processing.
